(19) United States
(12) Patent Application Publication
(10) Pub. No.: US 2009/0075677 A1
(43) Pub. Date: Mar. 19, 2009

(54) Dynamically Updated Proximity Warning

(75) Inventors: Patrik Seger, Malmo (SE); Leland Scott Bloebaum, Cary, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 11/855,344

(22) Filed: Sep. 14, 2007

(51) Int. Cl. H04Q 7/20

(52) U.S. Cl. 455/456.6

(57) ABSTRACT

Methods and apparatus are disclosed for alerting a mobile device user of the proximity of a target party. In an exemplary method, an electronic location information message corresponding to the target party is received, the electronic location information message including target location data. In response to the receipt of the location information message, a target location estimate is determined, based on the target location data. The target location estimate is compared to a bounded region surrounding a current position estimate for the mobile device, and an alert is selectively generated based on the proximity of the target location estimate to the bounded region. An application processor, configured to implement one or more methods for alerting the user of a mobile device of the proximity of a target party, is also disclosed. Various embodiments of the disclosed application processor may be used in an application server operatively connected to the mobile device through a communications network, or in the mobile device itself.

### BACKGROUND

The present invention relates generally to wireless communications systems and relates in particular to methods and systems for alerting a mobile device user to the proximity of a target party.

The concept of “geo-fencing” is well known. In the most common implementation of this concept, a “virtual” boundary is established around a fixed point or region by establishing a set of geographic coordinates defining the boundary. In this manner, a region of arbitrary shape can be established. Once established, a portable device with self-location capability (e.g., GPS receiver) can monitor when it is within the region bounded by the geo-fence and, if necessary and if equipped with a communication transceiver, report the status to a party responsible for monitoring the position of the device. Such solutions are commonly used in tracking of high-value assets, and are increasingly used in monitoring people, or even pets.

Conventional geo-fencing techniques, however, are typically intended to restrict a person or physical asset to a fixed area, perhaps surrounding a home or school, or to exclude someone (e.g. a criminal offender) from a fixed area. In some cases, it may be desirable to monitor a person's proximity to another person, while both persons are mobile. This need may arise for security reasons—a crime victim may wish to be notified if the paroled offender comes within a certain distance of the crime victim's current location, for instance. However, other applications for such notification are also possible. For example, a person may wish to be informed when any of her personal friends comes within a certain distance of her current location, or when any of her children travel farther away than a certain distance. Conventional geo-fencing techniques, because they are tied to a fixed location, cannot meet these needs.

### SUMMARY

Methods and apparatus are disclosed for alerting a mobile device user of the proximity of a target party. In an exemplary method, an electronic location information message corresponding to the target party is received, the electronic location information message including target location data. In response to the receipt of the location information message, a target location estimate is determined, based on the target location data. The target location estimate is compared to a bounded region surrounding a current position estimate for the mobile device, and an alert is selectively generated based on the proximity of the target location estimate to the bounded region.

In one or more embodiments, the determined target location estimate comprises a target location envelope based on the target location data and one or more uncertainty parameters associated with an originating source of the location information message. In some embodiments, the target location envelope may be further based on a previously determined target estimate. In several embodiments, an alert is generated when the target location envelope encroaches upon the bounded region surrounding the mobile device of the user. In some embodiments, the alert may include map data corresponding to the mobile device's current position, as well as indications of the mobile device's current position and/or the target party's estimated location.

An application processor, configured to implement one or more methods for alerting the user of a mobile device of the proximity of a target party, is also disclosed. Various embodiments of the disclosed application processor may be used in an application server operatively connected to the mobile device through a communications network, or in the mobile device itself.

### BRIEF DESCRIPTION OF THE DRAWINGS

FIG. 1 illustrates an exemplary wireless communications network.

FIG. 2 illustrates a target location envelope encroaching upon a dynamically-determined bounded region surrounding a mobile device.

FIG. 3 is a flow diagram illustrating an exemplary method for alerting a mobile device user to the proximity of a target party.

FIG. 4 is a flow diagram illustrating an exemplary method for determining a target location envelope.

FIG. 5 illustrates the effect of velocity information on an exemplary target location envelope.

FIG. 6 is a flow diagram illustrating the determination of a target location envelope according to one or more embodiments of the invention.

FIG. 7 is a flow diagram illustrating another exemplary method for alerting a mobile device user to the proximity of a target party.

FIG. 8 illustrates an exemplary mobile communications device configured to alert a user to the proximity of a target party.

### DETAILED DESCRIPTION

While the invention is susceptible to various modifications and alternative forms, specific embodiments thereof are shown by way of example in the drawings and will be described in detail below. It should be understood, however, that there is no intent to limit the invention to the particular forms described in detail. Those skilled in the art will recognize various alternatives to the illustrated embodiments falling within the scope of the claims.

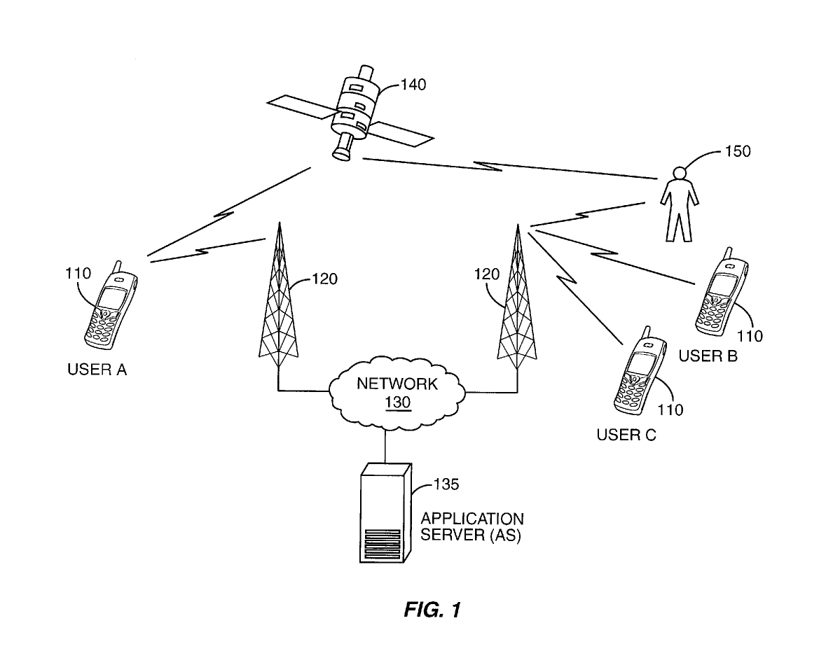

FIG. 1 illustrates a wireless communication system in which one or more embodiments of the present invention may be deployed. Several mobile devices 110 are configured to communicate with each other using wireless base stations 120 and network 130. Network 130 comprises the fixed portion of a wireless communications system, but may also comprise one or more private or public data networks, including the Internet. An application server 135 is connected to the network 130 as well, and is configured to communicate with one or more of mobile devices 110.

Signals from Global Positioning System (GPS) satellite 140 may be used by a mobile device 110 to determine its position. (Those skilled in the art will appreciate that satellite-based positioning technologies in addition to GPS, such as Russia's GLONASS system, the European Union's Galileo system, and India's IRNSS system, may also be used.) Methods for determining the position of a mobile device 110 using conventional satellite-based navigation system receivers are well known, and are not described in detail herein. In addition, various techniques are known for determining the location of a mobile device 110 using several cellular radio signals. These techniques include the use of the well-known Time-Difference-of-Arrival (TDOA) or Enhanced-Observed-Time-Difference (E-OTD) measurement schemes. Hybrid positioning schemes, involving the use of cellular signals as well as satellite positioning signals, are also known. Furthermore, technologies for enhancing the performance of GPS receivers in mobile devices, commonly known as Assisted-GPS, have been deployed.

The user of mobile device 110, “User A”, may wish to be notified any time that a particular person comes within a certain range of her current location. In FIG. 1, this person is shown as “arget party” 150. The location of target party 150 may be monitored by several different means. First, in some cases, target party 150 may be wearing or carrying a positioning device configured to periodically report its location to a centralized monitoring service. For instance, target party 150 may be compelled by court order to wear an “ankle bracelet” equipped with a GPS receiver and a communications module, so that government authorities can track the target's movements. In other cases, the target party's location might be determined through less authoritarian means. For example, target party 150 may carry a GPS-equipped mobile device 110 that periodically reports its location to a monitoring service. In this case, target party 150 may have explicitly authorized the sharing of that location information with User A.

Other sources of location information for target party 150 may also be used, instead of or in addition to GPS-based positioning devices. For instance, location information may be derived from the target party's use of an identification card or other authorization device. Presenting an identification badge to a work-place security gate, for example, might generate a location record. Similarly, electronic toll-collection transactions, such as those utilizing radio frequency transponders or bar codes, generate records that might be used as location information for target party 150. Further sources include first-hand reports from individuals. For instance, when User A's desire to track target party 150 is well known, then Users B and C in FIG. 1 might report sightings of target party 150 using their mobile devices 110. These reports might be oral, to a call center, by text message or e-mail, or by entry of “sighting” data into a web form. In each case, the sighting data is extracted from the report and made available to application server 135.

Location information corresponding to target party 150 may be collected at application server 135 through its connection to network 130, using conventional techniques. Location information from a mobile device 110 carried by target party 150, from an ankle bracelet worn by target party 150, or from personal sighting reports from mobile device users may all be routed to and collected at application server 135, which may be addressable, for instance, by an IP address, a Uniform Resource Locator (URL), or other electronic network address. Location reports triggered by various electronic transactions, such as the security gate transactions or toll transactions mentioned above, might also be routed to and collected at application server 135.

In some applications, the location information corresponding to target party 150 may be voluntarily provided by target party 150. For instance, target party 150 may authorize periodic updates to application server 135 of his location, perhaps using a positioning technology in a mobile device 110. That authorization may be general, allowing its unrestricted use, or may be limited to services pertaining to one or several specific authorized users. In other applications, the location information may be compulsorily provided, such as by court order. In still others, the only location information available may be that voluntarily provided by third parties, such as the personal reports mentioned above.

Location information corresponding to the system user, User A in FIG. 1, is also collected at application server 135. Because User A has typically requested the service, periodic updates of User A's location are generally easy to obtain. For instance, User A may have authorized periodic reports to application server 135 of position estimates obtained using the GPS technology in her mobile device 110. (Similarly, a mobile device user may authorize periodic or on-demand positioning reports obtained using cellular network-based location technologies.) Accordingly, it may generally be assumed that a current and reasonably accurate position estimate is always available for User A's mobile device 110, subject to well-known limitations of the particular positioning technology or technologies. For instance, GPS-based technologies may be ineffective when the mobile device 110 is deep inside a building, or in a parking garage. Similarly, of course, a current position estimate will be unavailable to the application server 135 if the mobile device 110 is unable to communicate with it, such as when no cellular coverage is available. However, in most circumstances, a current position estimate for User A's mobile device 110 will be available.

In contrast, location estimates for the target party 150 may in some cases be sporadic and uncertain. Although data from multiple sources may be combined in order to obtain more frequent estimates, data from various originating sources will differ in accuracy and reliability. For instance, certain data from official or quasi-official sources, such as data from security check-ins or toll-collection points, will generally be very accurate and, particularly in the case of the security-related data, very reliable in that the location estimate very likely corresponds to the correct target party 150. If the data is also timely, then the location estimate for target party 150 may be regarded as highly certain. On the other hand, data from a GPS-based positioning source, or based on cellular-based triangulation techniques, may be somewhat less accurate (to tens or perhaps hundreds of meters), and may be more or less reliable, depending on the exact source. For instance, a court-mandated ankle bracelet, attached to the target party with tamper-resistant security measures, will yield location estimates that are highly reliable in the sense that they are almost certain to correspond to the target party 150. Location estimates received from a mobile phone, on the other hand, are likely to be reasonably accurate, but somewhat less reliable, as the target party 150 may not actually be carrying the device when the location measurement is obtained.

Location estimates obtained from personal sighting reports, in contrast, may be quite precise, but may be less reliable, as the correspondence of the location data to the correct target is less certain. On the other hand, certain personal sighting reports may be less precise, perhaps only indicating a location descriptor (e.g. “Times Square”, or “downtown Raleigh”). This location descriptor may be used in some embodiments of the present invention to retrieve corresponding geographic coordinates. The precision of a location estimate derived from such a location descriptor is clearly a function of the precision of the descriptor itself—a descriptor such as “Radio City Music Hall” is clearly more precise than “Times Square.”

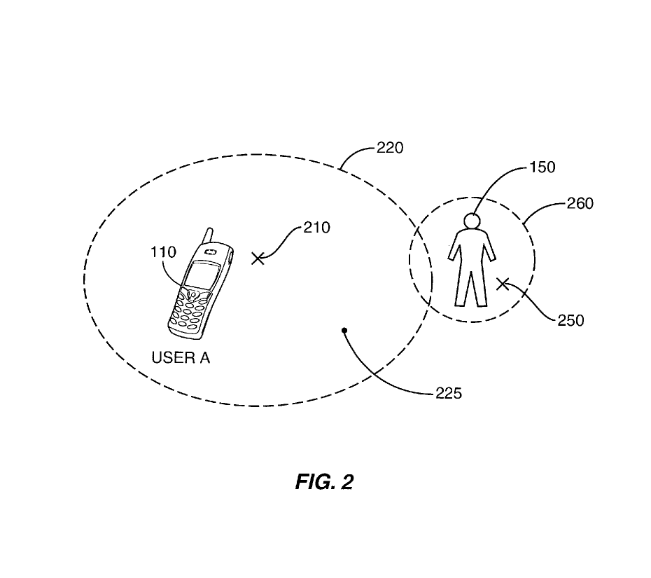

In order to ensure that User A is warned quickly enough, then, the uncertainty inherent in a location estimate for target party 150 should be accounted for. FIG. 2 illustrates how this may be accomplished. Mobile device 110, carried by User A, corresponds to a current position estimate 210. As discussed above, this position estimate 210 may be determined in a number of ways, but typically will be based on a GPS-based or cellular network-based positioning technology built into mobile device 110. User A's current position 210 is surrounded by a boundary 220, which defines a bounded region 225. In FIG. 2, bounded region 225 is depicted as roughly oval in shape, but, as will be discussed further, the bounded region 225 may in practice be any arbitrary shape.

Target party 150 is also illustrated in FIG. 2. Target party 150 is associated with a target location estimate. This target location estimate typically includes a point estimate, specifying a particular geographic location, shown as point estimate 250 in FIG. 2. However, this point estimate 250 has an inherent uncertainty associated with it. This uncertainty is represented in FIG. 2 as an envelope 260, surrounding the point estimate 250. Thus, the target location estimate may comprise a combination of the point estimate 250 and the envelope 260.

The size of the target location envelope 260 may be determined as a function of the source or sources of the target location estimate 250. As discussed above, some sources will be more accurate and/or more reliable than others; the target location envelope 260 size accounts for that variability. The size of target location envelope 260 may also be a function of the timeliness of the data used to construct the target location estimate. As the data ages, the location envelope 260 must grow in order to account for possible movement of target party 150 in the intervening time. The target location envelope 260 shape may also account for known movement—a GPS-based positioning report, for example, may include a velocity component indicating a direction and speed of travel. This information may be used to shape the target location envelope 260, since the target party's actual location at some slightly later time is more likely to be in the direction of last known motion.

Those skilled in the art will appreciate that data from multiple sources and multiple times may be combined to form a target location estimate. The data may be weighted to correspond to the corresponding source's reliability and/or accuracy, and to account for aging.

In any event, once a target location estimate is determined, it can be compared to the bounded region 225 surrounding User A to determine whether User A should be alerted of the target party's proximity. In FIG. 2, the target location envelope 260 intersects boundary 220 and extends into bounded region 225. In one or more embodiments of the invention, this overlap of the target envelope 260 and the bounded region 225 triggers a notification process to alert User A of the proximity of target party 150.

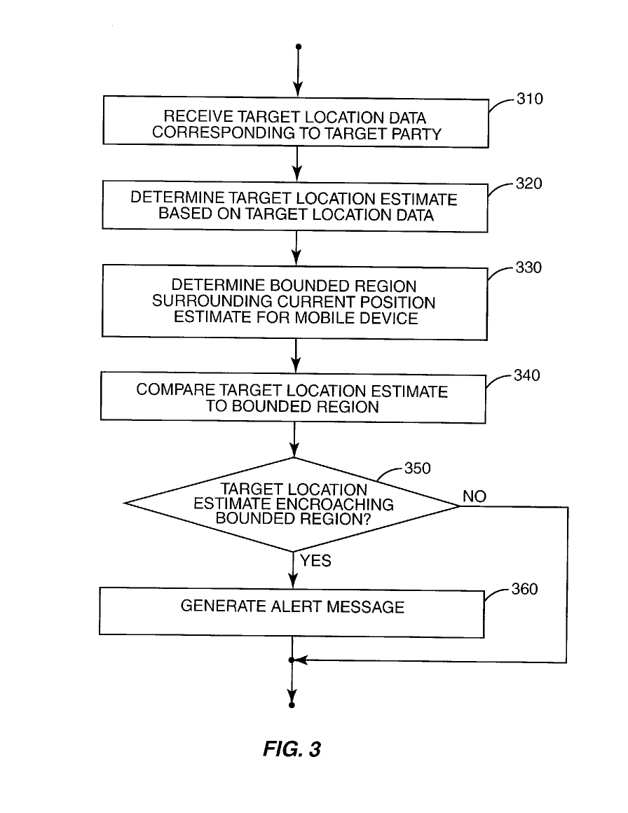

An exemplary method for alerting a user of a mobile device 110 of the proximity of a target party 150 is illustrated in FIG. 3. In one or more embodiments of the invention, this method is implemented with the application server 135 of FIG. 1, using location data received over network 130 from any or several of the above-described sources. The method flow begins at 310 with the reception of target location data corresponding to target party 150. Because this target location data may come from any or several of a variety of sources, it may vary in its precision, accuracy, and/or reliability. The reception of the target location data may in some embodiments trigger the execution of the remaining blocks of FIG. 3, while in other embodiments the remaining steps are performed periodically, or according to some other pre-determined schedule.

At block 320, the target location data is used to determine a target location estimate. As explained above, the target location data may be combined with other data to determine a target location estimate. The target location data may be analyzed in view of the source of the data to determine an uncertainty associated with the target location data. In some embodiments, the most recently received target location data may be combined with a previously determined target location estimate to obtain an updated target location estimate. In these embodiments, the target location data and the previous target location estimate may be weighted and summed to obtain an updated target location estimate. In some embodiments, the weighting may be a function of the age and/or the reliability of the newest target location data and/or the previous target location estimate.

At block 330, a bounded region surrounding a current position estimate for mobile device 110 is determined. In some embodiments, the bounded region is determined by simply applying a pre-determined separation distance, or range, to the current position estimate for the mobile device 110. In these embodiments, the bounded region will thus comprise a circular region centered on the current position estimate. In some embodiments, the range, which defines the radius of the circular bounded region, may be adjusted to account for uncertainty in the accuracy of the current position estimate for the mobile device 110. For instance, if the current position estimate is associated with an uncertainty of +/−100 meters (this uncertainty metric will often be accompanies by a probability, such as 95%, that the actual position falls within the range specified by the uncertainty), then the bounded region may be adjusted outwards by 100 meters to compensate for this uncertainty. Those skilled in the art will appreciate, however, that this adjustment becomes less significant as the size of the bounded region increases relative to the measurement uncertainty.

The current position estimate used to determine the bounded region may be obtained from another server, over network 130, or may be retrieved directly from mobile device 110. In one or more embodiments of the invention, the receipt of new target location data for target party 150 triggers a request for an updated position estimate for User A's mobile device 110. If the mobile device 110 supports autonomous position determination, this request may be sent directly to mobile device 110. Otherwise, the request may be sent to a location server, which may be operated by User A's cellular service provider. (The location server may track User A's location using any or several of a number of technologies, including those previously discussed. For instance, the location server may employ Assisted GPS technology, triangulation techniques such as E-OTD or TDOA, or may simply associate User A's location with the location of the serving base station.) In other embodiments, no request may be necessary, as current position estimates may be periodically sent to application server 135.

At blocks 340 and 350, the target location estimate is compared to the bounded region to determine whether the target location estimate encroaches upon the bounded region. If it does, then an alert message is generated to notify the user of mobile device 110 that the target party 150 is within (or is likely within) the proximity defined by the bounded region. Application server 135 may be configured to send the alert message to User A's mobile device 110, over network 130. The alert message may be sent, for example, using a Short Message Service (SMS) message, a Multimedia Messaging Service (MMS) message, an e-mail message, or the like. Referring back to FIG. 3, if no encroachment is detected at block 350, then, no alert message is generated, and the flow ends. The flow of FIG. 3 may be repeated on a periodic basis, or triggered when new target location data is received.

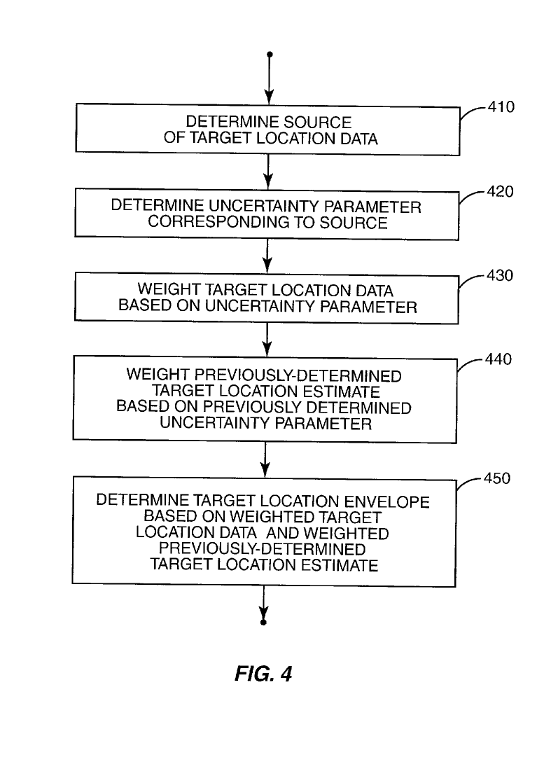

FIG. 4 illustrates the determination of a target location envelope based on the target location data. In the exemplary method of FIG. 4, the target location envelope is determined as a function of the received target location data and of a previously determined target location estimate. The flow begins at block 410, where a source for the received location data is determined. In some cases, determining the source of location data is as simple as reading an identifier attached to a location data message. In other cases, determining the source of location data involves matching a communications channel or type to a source. Several levels of distinction are possible. For instance, all location data reports received by text messages may be lumped together, and considered to be received from a single “text message source.” Alternatively, individual senders may be discriminated, so that the source of a given location data report is the individual sender.

In any case, at least one uncertainty parameter corresponding to the source is determined at block 420. In some cases, determining the uncertainty parameter comprises receiving an uncertainty metric along with or as part of the received location data. For instance, a location data report from a GPS receiver in the target party's mobile device 110 may specify a geographic location, generally using latitude and longitude coefficients, as well as an uncertainty parameter associated with the measurement. Cellular network-based measurements may also include an explicitly defined uncertainty parameter. For other sources, however, the uncertainty parameter corresponding to a particular report or source may not be explicitly defined. In these cases, determining an uncertainty parameter for a data source may comprise consulting a look-up table to retrieve a pre-determined parameter to use for a particular data source. A report received from a court-ordered monitoring device, for example, may be associated with one or more uncertainty parameters indicating a very low expected error as well as a high level of reliability. Similarly, a report received from a toll-collection point may correspond to uncertainty parameters indicating high accuracy, but only moderate reliability.

At block 430, the most recently received target location data is weighted, based on the uncertainty parameter or parameters. At block 440, a previously-determined target location estimate is weighted, based on a corresponding previously-determined uncertainty parameter. Finally, at block 450, the target location envelope is determined, based on the weighted target location data and the weighted previously-determined target location estimate. Those skilled in the art will recognize that various algorithms for determining the target location envelope are possible; the selection of the most appropriate will depend on the particular application and the available data sources. In a typical implementation, the weights for the new location data and for the previously-determined target location estimate are inversely proportional to the corresponding uncertainty parameters. Thus, location estimates with a lower uncertainty are weighted more heavily than those with greater uncertainty. A reference point for the target location envelope may be computed as the weighted average of the new target location data and the previously-determined target location estimate.

As an example, suppose that the previously determined location indicates location coordinates of x₁, y₁ with a corresponding uncertainty of 200 meters. In this example, the location coordinates x₁, y₁ identify a position relative to some local reference frame with an origin at a particular latitude and longitude. Those skilled in the art will appreciate that a variety of reference frames may be used to specify locations, including three-dimensional reference frames. In many cases, latitude and longitude may be used, although distance calculations are more complicated than with a linear reference frame. In some embodiments, an altitude measure may also be used. In any event, suppose further that a new location report is received, indicating a location of x₂, y₂, with an uncertainty of 500 meters. In an exemplary algorithm, the previously determined location is assigned a weight of 1000 times the inverse of the uncertainty, or 1000/200=5. Similarly, the new location report is assigned a weight of 1000/500=2. A new target location estimate is calculated as: (x_{new}, y_{new})=(5x₁+2x₂/(5+2), 5y₁+2y₂/(5+2)). This example, of course, is simplified; much more complex weighting algorithms are possible. For instance, the weights may take into account more than just a measurement accuracy uncertainty; the weights may include factors corresponding to the source reliability and/or to the age of the data. Furthermore, the weighting calculations need not be the same for the x and y directions.

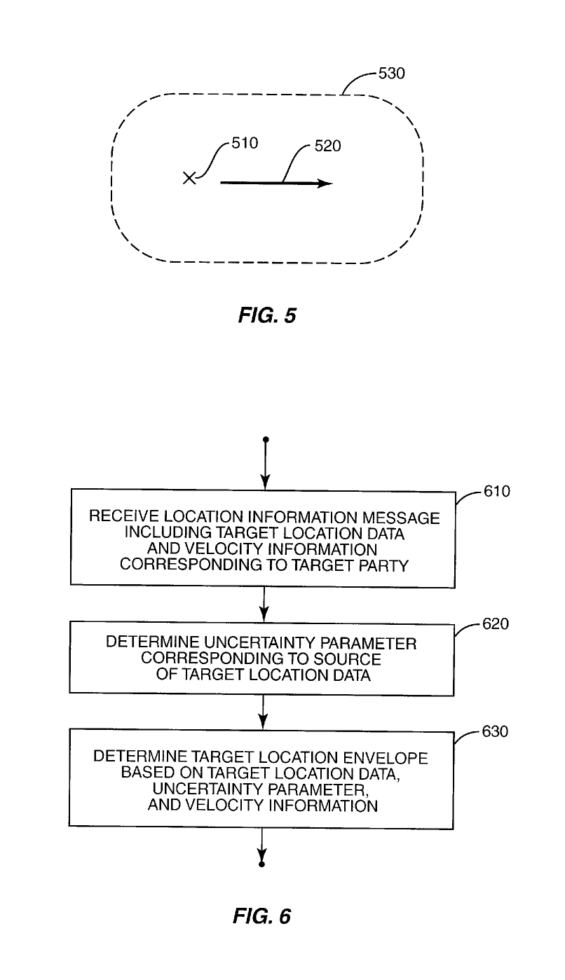

Indeed, the shape of the target envelope may vary with direction. For instance, if the target party 150 is known to be moving, the shape of the target location envelope may vary according to the estimated motion. In particular, the target location envelope may be elongated in the direction of the estimated motion, as shown in FIG. 5. In FIG. 5, target location data indicates a current position 510 for target party 150. However, the target location data also indicates that target party 150 is moving, as indicated by vector 520. Thus, the target location envelope 530 is elongated in the direction of the motion vector 520.

FIG. 6 illustrates an exemplary method for determining a target location envelope such as the target location envelope 530 pictured in FIG. 5. At block 610, a location information message is received, the message including target location data as well as velocity information corresponding to target party 150. At block 620, an uncertainty parameter corresponding to the source of the location information message is determined. As discussed above, this uncertainty parameter may comprise an explicit accuracy metric included in the location information message. At block 630, the target location envelope is determined from the target location data, the velocity information, and the uncertainty parameter. In an exemplary embodiment, the velocity information is converted to a velocity vector, which is used to scale the uncertainty parameter in the direction of that vector. With this approach, an elongated target location envelope similar to that pictured in FIG. 5 is obtained. Uncertainty with respect to the velocity information may also be considered; the overall size of the target location envelope may be increased to compensate for uncertainty in the velocity information.

As noted above, the bounded region surrounding the user's mobile device 110 need not be circular. Indeed, the bounded region need not have a regular shape at all. In some embodiments, the bounded region may be determined from a set of predetermined boundary-definition parameters and map data corresponding to the current location of mobile device 110. For instance, the boundary-definition parameters may specify that the boundary of the bounded region be at least 1000 meters from the mobile device position, but that the bounded region should be adjusted outward to encompass the nearest streets in each direction. Other boundary-definition parameters may specify that the bounded region extend further in a direction corresponding to a direction of motion estimated for mobile device 110.

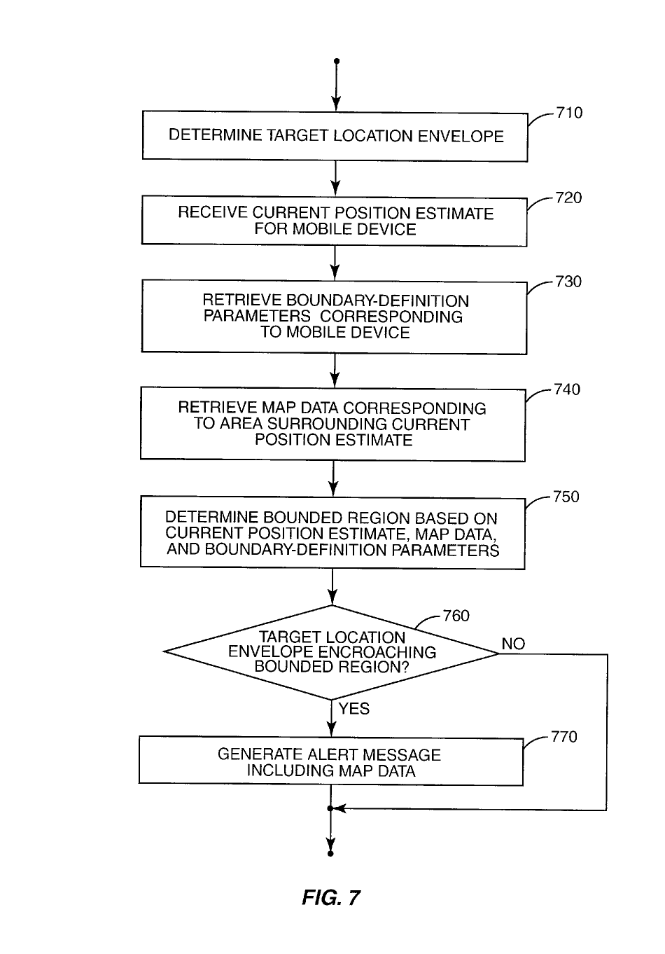

In each of these cases, the bounded region may be defined with reference to map data for the current location of the mobile device 110. FIG. 7 thus illustrates an exemplary method, which incorporates this map data, for alerting a mobile device user to the proximity of a target party.

At block 710, a target location envelope is determined, using any or several of the methods described above. At block 720, a current position estimate for the user's mobile device 110 is received. At block 730, boundary-definition parameters corresponding to the user's mobile device 110 are retrieved. In an exemplary embodiment, these boundary-definition parameters are retrieved from a look-up table stored in memory and indexed by a mobile device identifier. In any case, the current position estimate is used to retrieve map data corresponding to the area surrounding the current position estimate at block 740, and the boundary-definition parameters are used to determine a bounded region based on the current position estimate and the map data, at block 750. As noted above, the boundary-definition parameters may indicate, for example, that the bounded region be adjusted outwards from the current position estimate to encompass neighboring streets, or that the bounded region include the entire territory of the municipality in which the mobile device 110 is presently located.

At block 760, the target location envelope is compared to the bounded region to determine whether the target party is approaching the mobile device user. If the target location envelope encroaches on the bounded region, then an alert message is generated at block 770. In the exemplary flow of FIG. 7, the alert message includes map data, which may indicate the user's current location as well as the estimated location for the target party. The map data may include graphical data to be used directly by the mobile device 110 to render a map image, or may be an indicator pointing to map data that the mobile device 110 may retrieve, such as from a database or a separate server. In some embodiments, the alert message may further include suggested actions for avoiding the target party, such as a suggested route for maximizing the distance between the user and the target party.

In several embodiments of the current invention, one or more of the methods described herein are implemented at the application server 135 pictured in FIG. 1. Those skilled in the art will appreciate that the map data discussed above is readily retrievable at an application server 135. For instance, the map data may be stored in local memory at the application server, retrieved from an optical disk using an optical drive, or obtained from another server over network 130.

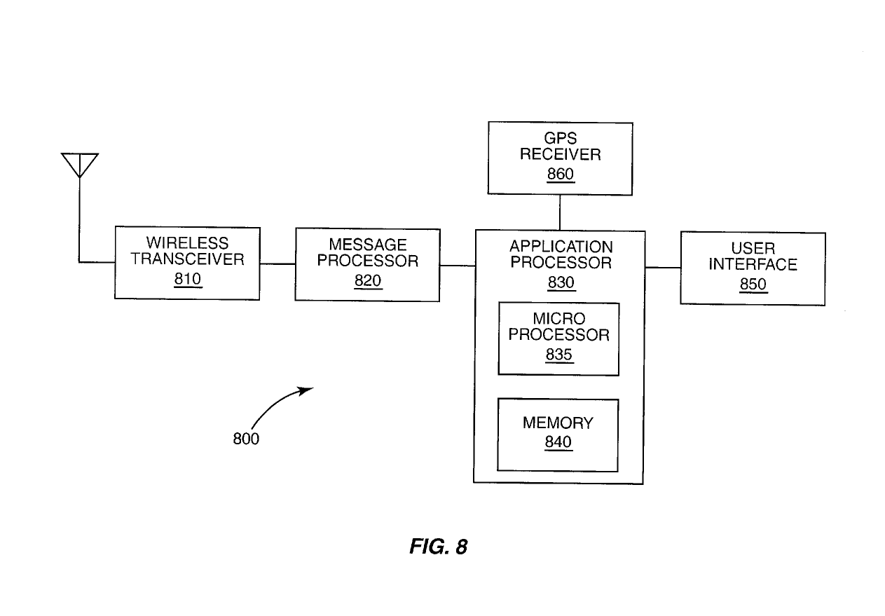

In other embodiments, all or a portion of a method for alerting a user to the proximity of a target party may be implemented on a mobile device carried by the user. Whether implemented at an application server 135 or at a mobile device, various method steps may be carried out using an application processor. An exemplary application processor 830 is thus pictured in FIG. 8, in the context of a mobile device 800 configured to alert its user to the proximity of a target party to the mobile device's current position.

The mobile device 800 of FIG. 8 comprises a wireless transceiver 810, which may be a conventional transceiver designed according to one or more wireless industry standards such as those promulgated by the 3^{rd}-Generation Partnership Project (3GPP) or by the 3^{rd}-Generation Partnership Project 2 (3GPP2). Thus, for example, wireless transceiver 810 may comprise a conventional GSM, W-CDMA, or WI MAX transceiver. Mobile device 800 further comprises a message processor, which is configured to receive an electronic location information message corresponding to the target party. This electronic location information message, which may comprise, for example, a text message or e-mail message, typically includes target location data indicating geographic coordinates for the target party's estimated location, and may include data defining a target location envelope.

Application processor 830, which in the exemplary configuration of FIG. 8 includes a microprocessor 835 and a memory 840, is configured to determine a target location estimate based on the target location data, to compare the target location estimate to a bounded region surrounding a current position estimate for the mobile device, and to selectively generate an alert message, using user interface 850, based on the proximity of the target location estimate to the bounded region. Determining the target location estimate from the target location data in the location information message may simply comprise extracting the target location estimate from the message. However, in other embodiments, determining the target location estimate may comprise determining a target location envelope using uncertainty information associated with the target location data. The target location estimate may also incorporate previously-determined location estimates, and may comprise a weighted average of one or more position estimates corresponding to the target party 150.

In the exemplary configuration of FIG. 8, current position information may be obtained using GPS receiver 860. In some embodiments, the receipt of new location data for target party 150 may trigger a positioning update operation, in which application process 830 requests a current position estimate from GPS receiver 860. In other embodiments, GPS receiver 860 may be configured to periodically supply position data to application processor 830, so that a current position estimate is readily available. Although mobile device 800 includes a GPS receiver and is configured for autonomous position determination, other mobile devices may be incapable of determining their own position without assistance from the mobile network, while other devices may have no position-related functionality built in at all. In either of these cases, determining a current position estimate may require that a request be sent from the mobile device to a network-based positioning service.

The alert message triggered when the target location envelope encroaches on the bounded region may comprise an audio alert, a text alert, a graphical alert, or any combination. In some embodiments, map data corresponding to the mobile device's current location may be available, in which case the alert message may comprise a visual map output indicating the current location of the mobile device 800 and the target party 150. A suggested action, or a suggested direction of travel to minimize the chance of encountering the target party 150, may also be included. In some embodiments, the alert message might also include an estimate of the time until the target party 150 is encountered if no change in direction is made.

While most of the above discussion assumes that the target party is someone that a mobile device user wishes to avoid, those skilled in the art will appreciate that the techniques described may be used to alert a user to the proximity of a friend or colleague as well. Thus, in one embodiment, the above techniques are practiced with respect to each person on a pre-determined list of friends, so that the mobile device user is alerted to the proximity of any one of those friends. Similarly, although the alert messages described above are generated when a target location envelope first encroaches upon a bounded region, other applications may specify that an alert message is generated when a target location envelope leaves a bounded region.

Those skilled in the art will also recognize that several of the functional elements of the application server 135 or the mobile device 800 described above, including, but not limited to the several functions of the applications processor 830, may be implemented on one or more microcontrollers or microprocessors, and may be implemented together or separately, with appropriate applications program interfaces between them. One or more of these elements may be implemented on a processor embedded in the wireless transceiver 810, for example. Alternatively, several of the functional elements of mobile device 800 described above may be provided through the use of dedicated hardware, as well as hardware capable of executing software in association with appropriate software or firmware. Furthermore, the term “processor” or “controller” does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Those skilled in the art will appreciate the cost, performance, and maintenance tradeoffs inherent in these design choices.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method for alerting the user of a mobile device of the proximity of a target party, comprising:
receiving an electronic location information message corresponding to the target party, said electronic location information message including target location data;
responsive to the electronic location information message, determining a target location estimate based on the target location data;
comparing the target location estimate to a bounded region surrounding a current position estimate for the mobile device; and
selectively generating an alert at the mobile device based on the proximity of the target location estimate to the bounded region.

2. The method of claim 1, wherein the target location estimate comprises a target location envelope, and wherein determining a target location estimate comprises determining the target location envelope based on the target location data and an uncertainty parameter associated with an originating source of the location information message.

3. The method of claim 2, wherein determining the target location envelope is further based on a previously determined target location estimate.

4. The method of claim 3, wherein determining the target location envelope comprises weighting the target location data based on the uncertainty parameter and weighting the previously determined target location estimate based on a previously determined uncertainty parameter.

5. The method of claim 2, wherein determining the target location envelope is further based on velocity information included in the electronic location information message.

6. The method of claim 2, wherein selectively generating an alert at the mobile device based on the proximity of the target location estimate to the bounded region comprises generating an alert when the target location envelope encroaches upon the bounded region.

7. The method of claim 2, wherein selectively generating an alert at the mobile device based on the proximity of the target location estimate to the bounded region comprises generating an alert when the target location envelope is outside the bounded region.

8. The method of claim 1, wherein the target location data comprises a location descriptor, and wherein determining a target location estimate based on the target location data comprises retrieving geographic coordinates corresponding to the location descriptor and determining the target location estimate based on the geographic coordinates.

9. The method of claim 8, wherein the target location estimate comprises a target location envelope, and wherein determining a target location estimate comprises determining the target location envelope based on the geographic coordinates and an uncertainty parameter associated with the location descriptor.

10. The method of claim 1, wherein comparing the target location estimate to a bounded region surrounding a current position estimate for the mobile device is performed remotely from the mobile device, further comprising requesting the current position estimate from the mobile device for use in the comparing.

11. The method of claim 1, wherein comparing the target location estimate to a bounded region surrounding a current position estimate for the mobile device is performed at the mobile device, further comprising performing a positioning update operation to obtain the current position estimate.

12. The method of claim 11, wherein initiating a positioning update operation comprises receiving the current position estimate from a satellite-based navigation system receiver.

13. The method of claim 11, wherein initiating a positioning update operation comprises requesting the current position estimate using a wireless network.

14. The method of claim 1, wherein comparing the target location estimate to a bounded region surrounding a current position estimate for the mobile device comprises determining the bounded region based on the current position estimate and map data corresponding to an area surrounding the current position estimate.

15. The method of claim 1, wherein generating an alert at the mobile device based on the proximity of the target location estimate to the bounded region comprises sending an alert message to the mobile device.

16. The method of claim 15, wherein the alert message comprises map data indicating the current position estimate and the target location estimate.

17. The method of claim 15, wherein the alert message comprises suggested actions for the user of the mobile device.

18. An application processor configured to:
receive an electronic location information message corresponding to a target party, said electronic location information message including target location data;
responsive to the electronic location information message, determine a target location estimate based on the target location data;
compare the target location estimate to a bounded region surrounding a current position estimate for a mobile device; and
selectively generate an alert message based on the proximity of the target location estimate to the bounded region.

19. The application processor of claim 18, wherein the target location estimate comprises a target location envelope, and wherein the application processor is configured to determine the target location envelope based on the target location data and an uncertainty parameter associated with an originating source of the location information message.

20. The application processor of claim 19, wherein the application processor is further configured to determine the target location envelope based on a previously determined target location estimate.

21. The application processor of claim 18, wherein the application processor is configured to determine the bounded region using the current position estimate and map data corresponding to an area surrounding the current position estimate.

22. The application processor of claim 19, wherein the application processor is configured to receive the current position estimate from the mobile device for use in the comparing and to send the generated alert message to the mobile device.

23. A mobile communications device, comprising:
a message processor configured to receive an electronic location information message corresponding to a target party, said electronic location information message including target location data; and
an application processor configured to:
determine a target location estimate based on the target location data, responsive to the electronic location information message;
compare the target location estimate to a bounded region surrounding a current position estimate for the mobile communications device; and
selectively generate an alert message based on the proximity of the target location estimate to the bounded region.
